(19) United States
(12) Patent Application Publication
(10) Pub. No.: US 2002/0100880 A1
(43) Pub. Date: Aug. 1, 2002

(54) APPARATUS FOR DECELERATING ION BEAMS FOR REDUCING THE ENERGY CONTAMINATION

(76) Inventors: JIN-LIANG CHEN, CUPERTINO, CA (US); LINUAN CHEN, SAN JOSE, CA (US)

Correspondence Address: BO-IN LIN, 13445 MANDOLI DRIVE, LOS ALTOS HILLS, CA, 94022

(21) Appl. No.: 09/419,380

(22) Filed: Oct. 15, 1999

(51) Int. Cl. G21K 5/10

(52) U.S. Cl. 250/492.21

(57) ABSTRACT

An ion implantation apparatus is disclosed in this invention. The ion implantation apparatus includes a target chamber for containing a target for implantation and an ion source chamber includes an ion source for generating an ion beam. The ion source chamber further includes an ion beam steering means for steering the ion beam through a curved beam-trajectory to a targeted ion-beam direction. The ion source chamber further includes a beam deceleration optics for decelerating and filtering the ion beam for spreading out the ion beam over an angular range according to an energy and an electric charge of each ion of the ion beam. The ion beam apparatus is able to more accurately direct a low energy ion to a target wafer. The ion beam steering means coordinating with the beam deceleration means for generating an electromagnetic field for separating neutralized particles from charged particles by steering the neutralized particles to transmit in a neutralized-particle direction slightly different than the targeted ion-beam direction. The beam deceleration optics further includes a plurality of electrodes for generating an electric field for spreading the charged ion beam over an angular range to accurately control the trajectory paths of ions of different energy levels. The purpose is to eliminate the energy contamination by more accurately controlling the energy range of the charged ions to reach the target for implantation and to block the neutralized particle and ions of higher energy from reaching the target for implantation.

### BACKGROUND OF THE INVENTION

1. Field of the Invention

The invention relates generally to an ion implantation apparatus that is provided to decelerate the ion beams to sub-keV energies for substantially eliminating energy contamination. More particularly, this invention relates to the improved deceleration optics that can also function as an energy-filter to allow only the ion particles of particular range of energies to reach the targeted wafers.

2. Description of the Invention

Technical difficulties of energy contamination is still a challenge faced by a person of ordinary skill in the art of semiconductor industry, particular for ion implantation with implanting energy less than one KeV. Specifically, as the dimension of the semiconductor device continues to shrink in the last decade, for the device with dimension of 0.18 μm or less, ion energies for ion implantation should be 1 keV or less to form shallow junctions. This is particularly true for implantation of boron ions. For a conventional high current ion implanter, an ion beam is extracted from an ion source, travels through a mass analyzer, and then reaches semiconductor wafers. The travel distance from the source to the wafers is usually about two meters. For an ion beam with energy as low as 0.2 keV and beam current as high as 10 mA, the space charge of the beam is so high that the ion beam starts to blow up severely as soon as it gets out of the source. This difficulty exists regardless what kind of focusing beam optics is used. After the ion beam travels about two meters, there is not much beam current left for implantation. An efficient way to obtain high beam current for low ion energy is to decelerate an ion beam from higher energy, e.g. 5 keV, to low energy, e.g. 1, 0.5, or 0.2 keV, at a region close to the wafers. Although the beam may also blow up after deceleration, there is still a plenty of beam current left for implantation since the distance between the deceleration region and the wafers is usually less than 0.4 meter. With the help of a plasma or electron shower, the beam will blow up less and the beam transmission can be improved.

This above method is able to achieve high beam intensities from high beam currents at energies below 5 keV by extracting ions at higher energies than the desired energy level, mass analyzing the ions and then decelerating the ion beam before reaching the targets. However, high-energy neutrals are resulted in the region between the mass analyzer and the deceleration electrodes when the higher energy ions interact with residual gases in the beam line. These neutrals will not be decelerated by the deceleration electric fields and reach the wafers at higher energies. This energy contamination can lead to a deeper dopant depth profile. The energy contamination is only tolerable to ˜0.1% in order to provide sufficient margin against shifts in device performance. [L. Rubin, and W. Morris, “Efects of Beam Energy Purity on Junction Depths in Sub-micron Devices”, Proceeding s of International Conference on Ion Implantation Technology, 1996, p96]. It requires the chamber pressures be kept sufficiently low (5.0E-7 torr). This pressure is very difficult to be maintained under normal operating conditions of an implantation system due to the out-gassing of the photo-resist coating of patterned devices and feeding gases of plasma showers that provide electrons to prevent wafers from positively charging caused by ion beams. Another issue is variations in the level of contamination. Pressure fluctuations during the implant can cause across wafer effects. Day to day changes in residual vacuum or photo-resist quality cause batch to batch effects. Finally, a potential danger of loss of wafers worth for million dollars exists due to the undetected vacuum problems such as shifting of pressure gauge readings.

For all the above reasons, traditional techniques of ion implantation using conventional types of energy deceleration systems by applying an ion particle deceleration technology as described above do not provide a viable solution for the difficulties currently associated with the fabrication processes employing very low energy implantation. There is a profound need in the art of IC device fabrication, to provide new systems for very low energy implants. Particularly for devices that require shallow p-type and n-type junctions, new methods and systems are required to resolve these difficulties and limitations with effective control over energy contamination of low energy beam.

### SUMMARY OF THE PRESENT INVENTION

It is therefore the object of the present invention to provide a new ion implant system for low energy implants to form shallow p-type and n-type junctions in semiconductor devices. The new ion implant system with novel magnetic analyzer and deceleration optics will enable those of ordinary skill in the art to overcome the difficulties, encountered in the prior art.

Specifically, it is an object of the present invention to present a new ion beam steering and deceleration system for decelerating a charged ion beam and for separating a neutralized beam from the ion beam. The neutralized beam at higher energy levels is separated and stopped by a neutralized-particle-stopping block without reaching the target wafer for implantation. The charged ion beams is further filtered and focused by the ion beam deceleration optics to become an angular-spread-out beam for more accurately controlling the implanting energy of the charged ions. The difficulties in carrying out a very low energy implant caused by low-energy ion-beam energy contamination as a result of neutralized particles incident to the target with higher energies are resolved.

Another object of the present invention is to provide a new ion beam steering and deceleration system by implementing a novel beam deceleration optics. The new beam deceleration optics is employed for more accurately controlling the energy range of the charged ions for implantation by using a new method to filter the charged ions such that the charged ions are projected as an angular-spread-out beam. The neutralized particles are thus induced to travel along a separated beam path from the charged particles and prevented from reaching the target wafer. The deceleration optics for directing the charged beam is further configured to assure charged particles of higher energy ranges are also blocked.

Another object of the present invention is to provide an implant system with new ion beam steering and deceleration system for decelerating a charged ion beam and to more accurately control the energy ranges of the implanting beam. The electrodes of the beam deceleration optics are configured to move in a traversal direction relative to the beam line such that the beam can be steered to travel further away from the neutralized and high-energy particles to further assure that only low energy ions are employed for implantation.

Briefly, in a preferred embodiment, the present invention discloses an ion source apparatus for generating and directing an ion beam. The ion source apparatus includes a beam deceleration optics for decelerating and filtering the ion beam. The beam deceleration optics further includes a plurality of electrodes for generating an electrical field for filtering and spreading out the ion beam over an angular range according to energy of each ion of the ion beam for more accurately directing a low energy ion to a target wafer.

More specifically, an ion implantation apparatus is disclosed in this invention, which includes a target chamber for containing a target for implantation and an ion source chamber includes an ion source for generating an ion beam. The ion source chamber further includes an ion beam steering means for steering the ion beam through a curved beam-trajectory to a targeted ion-beam direction. The ion source chamber further includes a beam deceleration optics for decelerating and filtering the ion beam for spreading out the ion beam over an angular range according to an energy and an electric charge of each ion of the ion beam. The ion beam apparatus is able to more accurately direct a low energy ion to a target wafer. The ion beam steering means coordinating with the beam deceleration means for generating an electromagnetic field for separating neutralized particles from charged particles by steering the neutralized particles to transmit in a neutralized-particle direction slightly different than the targeted ion-beam direction. The beam deceleration optics further includes a plurality of electrodes for generating an electric field for spreading the charged ion beam over an angular range to accurately control the trajectory paths of ions of different energy levels. The purpose is to eliminate the energy contamination by more accurately controlling the energy range of the charged ions to reach the target for implantation and to block the neutralized particle and ions of higher energy from reaching the target for implantation.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram showing how the deceleration optics of this invention separates a decelerated ion beam and the neutralized beam in an ion source implanter system; and

FIG. 2 is a functional block diagram showing how the deceleration optics of this invention acts as an energy filter; and

FIG. 3 is a schematic diagram of the major beam line components at different voltages; and

FIG. 4 is the cross-section diagram of the electric field distribution and ion beam trajectories in the deceleration region; and

FIG. 5 is a three-dimensional view of the mechanical design of the deceleration electrode assembly of this invention.

### DETAILED DESCRIPTION OF THE PREFERRED EMBODIMENT

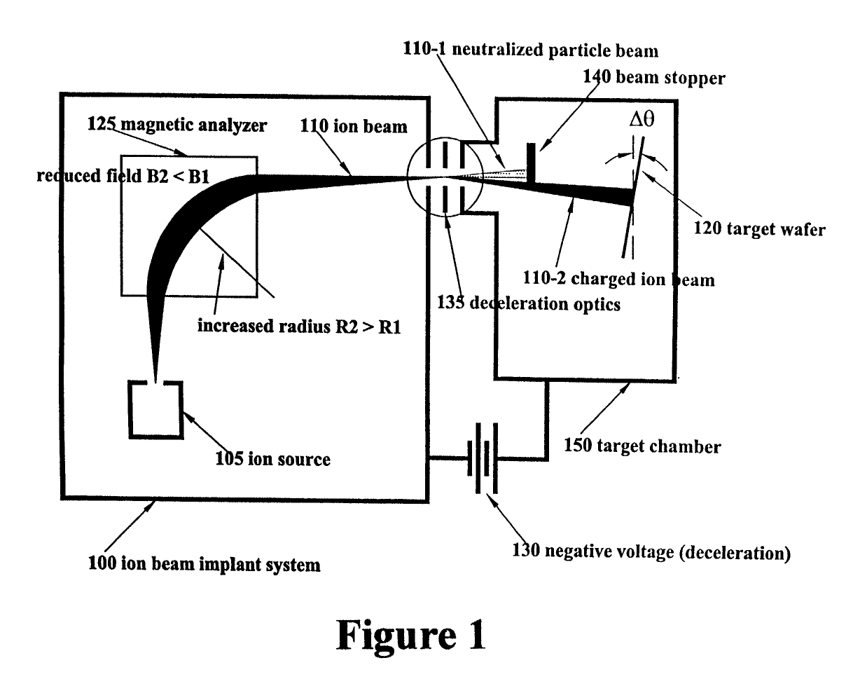

FIG. 1 is a functional block diagram for showing the ion implant system 100 of this invention. A solution to the difficulties of the energy contamination is disclosed. The deceleration optics as further described below can decelerate an ion beam from higher energy, e.g. 5 keV, to energy as low as 0.2 keV, and at the same time steer the decelerated ion beam to an angular-spread-out beam according to ion particle energy range. The angular-spread-out characteristic of the ion beam provides a convenient method for selectively block out beam in certain energy range by employing simple mechanical means of beam stoppers. Referring to FIG. 1 for the ion beam implant system 100 that includes the ion source associated with ion-beam formation electrodes 105, the mass analyzer magnet 125, post analysis deceleration electrode 135, and target chamber 150 for implanting a target wafer 120 with an ion beam 110.

Under normal operation (no ion beam deceleration), the ion beam 110 is steered and transported through the central line of the mass analyzer magnet 125, with the bending radius of the curve R in the unit of centimeter satisfying the following equation,

$$R = \frac{144}{B} {( M * E )}^{0.5} \qquad ( 1 )$$

where M is the mass of the particle in atomic mass unit (amu), E is the energy of the particles in the unit of eV, and B is the magnetic field of the magnetic analyzer in the unit of Gauss.

Under the operation for ion beam deceleration, the ion beam 110 is steered by a magnetic analyzer 125 where the magnetic field is reduced by turning down the current of the magnetic coils. By reducing the magnetic field of the magnetic analyzer 125, the curved trajectory of the ion beam 110 is out-shifted with the outer edge of the beam extended to a greater radius when compared with the conventional ion beam as that discussed above.

After the ion beam 110 passes through the magnetic analyzer 125, a deceleration voltage 130 is applied to decelerate the ion beam 110 as shown in FIG. 1. When the ion beam 110 is a positively charged ion beam, a negative voltage 130 is applied. As the ion beam 110 travels through the ion beam system 100, some charged particles may be neutralized. The deceleration voltage will not decelerate the neutralized particles because they do not carry any charges. The traveling speed of such particles is not affected by the electric field. After passing through the deceleration optics 135 that has bending ability for charged particles, the path of the neutral particles and the charged particles are therefore separated during deceleration and becomes two separate beams 110-1 and 110-2. The neutralized particle beam 110-1 is traveling along a straight line while the charged ion beam 110-2 becomes a spread out beam by employing a special deceleration optics as will be discussed below. The charged ion beam, now becomes a angular spread-out beam, is traveling along a path with a slightly downward angle, e.g., a six-degree downward bent path, to reach the target wafer 120. It is noted that the charged ion-beam spread out over an angular range depending on the ion particles as will be further discussed below. A beam stopper 140 is employed on the path of the neutralized particle beam 110-1 to block the neutralized beam 110-1 to reach the target wafer 120. The target wafer 120 is placed with a small slant angle, e.g., six-degree angle relative to a vertical direction for perpendicularly facing the charged ion beam 110-2. By putting a beam stopper 140 at the original beam path 110-1 after the deceleration optics, the neutral particles can be blocked, allowing the decelerated and steered ion beam to reach the wafer 120. By arranging the steering angle with sufficient angular bending the difficulties of the overlapping of the neutral and charged ion beams can be overcome. The problem of the energy contamination induced in the wafers can be resolved.

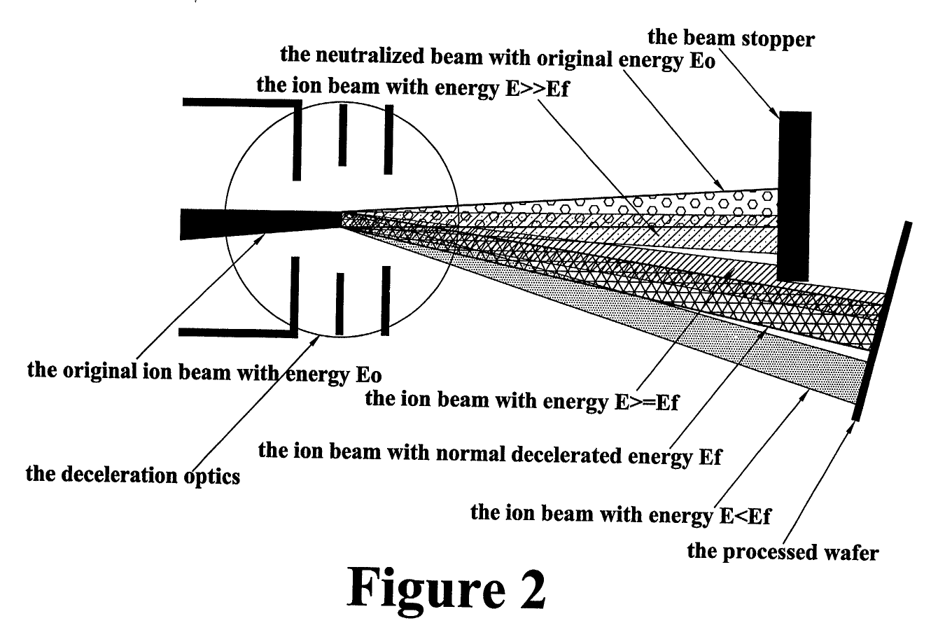

Referring to FIG. 2, the angular-spread-out ion beam generated by deceleration optics with the steering function particularly configured as an energy filter. According to Equation (1), the downward bending angle is a function of radius R, which in turn is a function of the ion energy. For a specific beam deceleration optics, the downward bending angle is larger, i.e., having a smaller radius of curvature, for smaller energy. Conversely, the radius of curvature R is greater that results in a smaller downward bending angle for larger energy. Suppose that the steering angle for ions with original energy E₀ and decelerated final energy E_{F} is θ₀. Under normal process of ion beam formation, an ion beam is typically generated that has ions with different energies ranging from E₀−dE₁ to E₀+dE₂. Referring to FIG. 2, ions with energy much higher than E₀ will have small steering angles θ<<θ₀ and thus will be blocked by the beam stopper as shown in FIG. 2. Ions with energy higher but close to E₀ will be partially blocked. Ions with energy smaller than E₀ will not be blocked and some of them may reach the wafers. Since the effects of energy contamination are very minimal with ions that have energy ranging from much smaller than E₀ to a little bit larger than E₀, when E₀ is <1 keV as deceleration is required, the problems caused by energy contamination can be significantly resolved with a beam stopper 140 as that shown in FIGS. 1 and 2. Even with some glitches in the process of ion formation that causes the original ion beam to have a certain energy range, the implant profile for shallow junction formation can be carried out without being adversely affected by the technical difficulties of energy contamination.

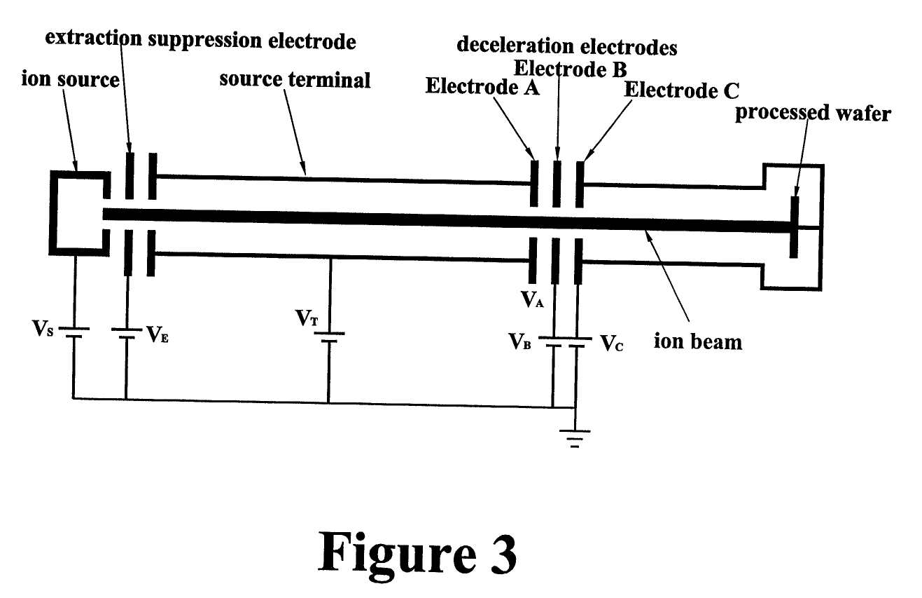

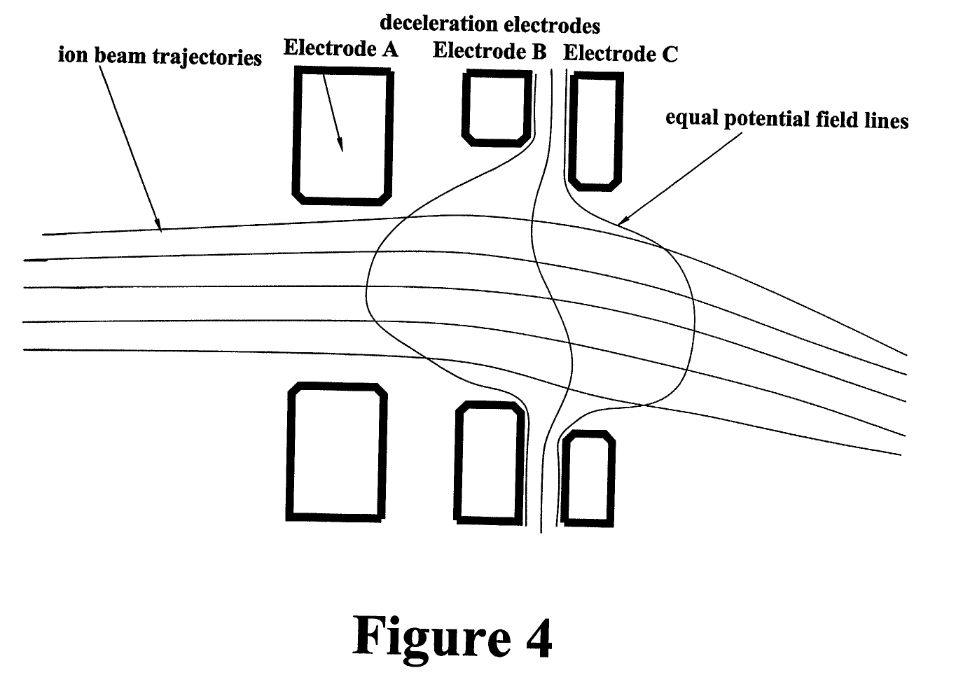

Referring to FIGS. 3 and 4 for the schematic diagram of the deceleration optics 135 and the electrical voltage arrangement of the electrodes employed in the deceleration optics 135 of the present invention. The deceleration optics consists of three electrodes A, B, and C. The voltages of the ion source, the extraction suppression electrode, and the source terminal are shown in FIG. 3 as V_{S}, V_{E}, and V_{T} respectively. Electrode A is at a potential V_{A} and is equal to the ion source termination potential V_{T} (V_{A}=V_{T}). The deceleration suppression electrode B is at a potential V_{B} that is more negative than V_{A} (V_{B}<V_{A}). Electrode C is at a potential V_{C} that is equal to the potential of the processed wafers, and is more positive than V_{A} (V_{A}<V_{C}). The original ion energy E₀ is equal to q(V_{S}−V_{T})=q(V_{S}−V_{A}), and the decelerated ion energy E_{F} is equal to q(V_{S}−V_{A})−q(V_{C}−V_{A})=q(V_{S}−V_{C}), where q is the charge of an ion in the beam and usually positive. In most ion implanters, the processed wafers are connected to ground (V_{C}=0). However, we should still have options to connect either the ion source or source terminal to ground (V_{S}=0 or V_{T}=V_{A}=0).

Since V_{B} is more negative than V_{A} and V_{C} (V_{B}<V_{A}<V_{C}), Electrode B can suppress both the upstream and downstream electrons. Electrode B can also provide focusing while the beam is being decelerated and steered. From the electrode cross section diagram in FIG. 4, it can be noted that Electrode B and Electrode C displaces transversely off the centerline of Electrode A in the opposite direction. Both the electric field between Electrode A and B and the field between Electrode B and C steer the ion beam downward. Electrode C is controlled by a manipulator and can move transversely to steer the ion beam with the correct angle so that the ion beam can reach the wafer position. The steering angle is a function of the original and final energies of the ion beam and the electric field distribution in the deceleration region. For different original and final energies of the ion beam (or different combination of (V_{S}−V_{A}) and (V_{S}−V_{C})), the parameters affecting electric field distribution, including the suppression voltage V_{B} and the transverse position of Electrode C, have to change to keep the steering angle unchanged so that the ion beam can always reach the same wafer position. Since the suppression voltage V_{B} is primarily used to focus the ion beam, its value is usually changed to give the proper focusing while the transverse position of Electrode C is changed to give the proper steering.

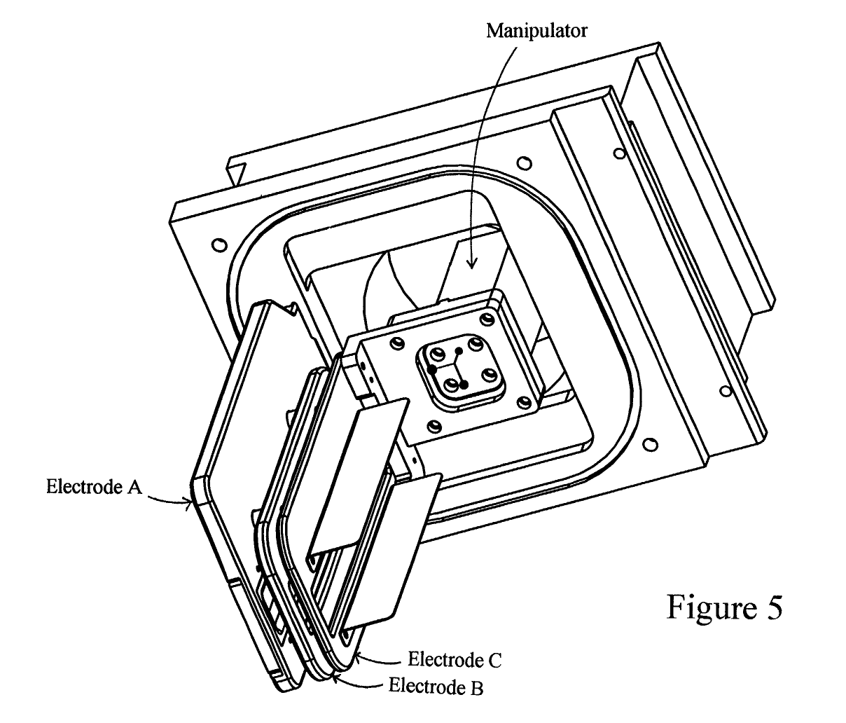

FIG. 5 shows a three-dimensional perspective view of the mechanical design of the deceleration electrode assembly. The apertures of the three electrodes are narrow and tall. The electrodes are designed to accept narrow and tall beams since these beams give small beam densities with large mass resolution especially for beams with low energies and high currents. Narrow beams are easier to have complete separation than wide beams as shown in FIG. 1 after the original beams are decelerated and steered. The width of Electrode B is larger than the widths of Electrode A and C. One reason is to prevent ion beams from striking on Electrode B, generating large secondary electrons, and overloading the suppression power supply. The other reason is to provide better focusing field distribution. When the width of Electrode B is smaller than that of Electrode C, the transverse field components at the edge of Electrode C is high, which may deflect ions out of the beams.

The deceleration optics of the present invention provides an apparatus to decelerate ion beams, especially for those with low energies and high currents, and at the same time steer these decelerated beams off the path of the original ion beams, therefore separate the decelerated ion beams and the neutralized beams that travel in the direction of the original ion beams. By blocking the neutralized beams with a beam stopper, the energy contamination resulted from deceleration can be eliminated.

The invention thus discloses an ion implantation apparatus, which includes a target chamber for containing a target for implantation and an ion source chamber includes an ion source for generating an ion beam. The ion source chamber further includes an ion beam steering means for steering the ion beam through a curved beam-trajectory to a targeted ion-beam direction. The ion source chamber further includes a beam deceleration optics for decelerating the ion beam for producing a low energy ion beam. The ion beam steering means coordinating with the beam deceleration means for generating an electromagnetic field for separating neutralized particle by steering a neutralized particle to transmit in a neutralized-particle direction slightly different from the targeted ion-beam direction. The ion-beam deceleration optics further includes electrodes for filtering charged particles of the ion beam for generating a spread-out ion beam over an angular range along a beam line of the ion beam. The spreading out is according to energy of each ion of the ion beam for more accurately controlling the energy of the ions for implantation and for blocking the neutralized particle and the ions above a maximum implant energy from reaching the target for implantation. In a preferred embodiment, the ion-beam deceleration optics includes a first, a second and a third electrodes arranged in sequence along an incident direction of the ion beam for generating an ion-beam filtering electric field wherein the second electrode is provided with a more negative voltage than the first electrode and the third electrode is provided with a more positive voltage than the first electrode. In a preferred embodiment, the first electrode is provided with a voltage same as an ion source terminal voltage and the third electrode is provided with a voltage same as a wafer voltage. In another preferred embodiment, the third voltage is provided with a wafer voltage connected to a ground voltage. In another preferred embodiment the ion beam steering means includes an analyzer magnet for steering the ion beam through the curved beam-trajectory producing a beam-curvature spread having a range of radius R of the curved beam-trajectory as R=K*[M*E]^{0.5}/B and K being a constant, M being a mass of an ion particle of the ion beam, B being a magnetic field of the magnetic analyzer, and E being an energy level of an ion in the ion beam. In another preferred embodiment, the ion-beam deceleration optics further includes a neutralized beam blocking means for blocking the neutralized particle from reaching the target of implantation in the target chamber. In another preferred embodiment, the beam deceleration optics further includes a high energy beam blocking means for blocking ions of the ion beam having an energy higher than a maximum implant energy by placing the high energy beam blocking means at a pre-designated angular position along the beam line corresponding to an angular range for blocking ions of the ion beam having an energy higher than the maximum implant energy. In another preferred embodiment, the ion-beam deceleration optics includes at least two beam-path openings on ion-source chamber for transmitting the ion beam steered by the steering means with a curved beam-trajectory having a range of trajectory radii. In another preferred embodiment, the ion source is an ion source for generating a positive charged ion beam and the beam deceleration optics includes the electrodes for generating a negative energy filtering electric-field for decelerating and filtering the ion beam for producing a spreading-out ion beam over an angular range along the beam line of the ion beam. Ion another preferred embodiment, the ion beam steering means coordinating with the beam deceleration means for steering the ion beam carrying electric charges to transmit in the targeted ion-beam direction having a small vertically deflected angle of about six-degree relative to a horizontal axis as shown in FIG. 1 and 2. And, the target chamber containing the target for implantation leans at a small angle of about six-degree relative to a vertical axis perpendicular to the horizontal axis whereby the target for implantation is perpendicular to the incident angle of the ion beam. In another preferred embodiment, the ion source chamber is provided with a vacuum in the range of 10⁻⁵ Torr and the ion beam is decelerating to an energy level of about 200 eV with a beam energy contamination of about 0.1%.

In summary, an ion source apparatus for generating and directing an ion beam is disclosed in this invention. The ion source apparatus includes a beam deceleration-optics for decelerating and filtering the ion beam. The beam deceleration optics further includes a plurality of electrodes for generating an electrical field for filtering and spreading out the ion beam over an angular range according to energy of each ion of the ion beam for more accurately directing a low energy ion to a target wafer.

In summary, this, invention further discloses a method for generating an implantation ion beam. The method includes the steps of (a) providing an ion source for generating an ion beam; (b) employing an analyzer magnet for steering the ion beam through a curved beam-trajectory to a targeted ion-beam direction; (c) applying the ion beam steering means for coordinating with the beam deceleration means for generating an electromagnetic field for separating a neutralized particle by steering a neutralized particle to transmit in a neutralized-particle direction slightly different from the targeted ion-beam direction; and (d)employing a beam deceleration optics for decelerating and filtering the ion beam for producing a spreading out beam over an angular range along a beam line of said ion beam according to an energy of ions of the ion beam and employing a high energy ion blocking means for blocking out ions having an energy higher than a maximum implant energy.

Therefore, the present invention provides a new ion implant system for low energy implants to form shallow p-type and n-type junctions in semiconductor devices. The new ion implant system with novel magnetic analyzer and deceleration optics will enable those of ordinary skill in the art to overcome the difficulties, encountered in the prior art. Specifically, this invention discloses a new ion beam steering and deceleration system for decelerating a charged ion beam and for separating a neutralized beam from the ion beam. The neutralized beam at higher energy levels is separated and stopped by a neutralized-particle-stopping block without reaching the target wafer for implantation. The charged ion beams is further filtered and focused by the ion beam deceleration optics to become an angular-spread-out beam for more accurately controlling the implanting energy of the charged ions. The difficulties in caring out a very low energy implant caused by low-energy ion-beam energy contamination as a result of neutralized particles incident to the target with higher energies are resolved. The neutralized particles are thus induced to travel along a separated beam path from the charged particles and prevented from reaching the target wafer. The deceleration optics for directing the charged beam is further configured to assure charged particles of higher energy ranges are also blocked. This system can more accurately control the energy ranges of the implanting beam. The electrodes of the beam deceleration optics are configured to move in a transverse direction relative to the beam line such that the beam can be steered to travel further away from the neutralized and high-energy particles to further assure that only low energy ions are employed for implantation.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. An ion implantation apparatus comprising:
a target chamber for containing a target for implantation and an ion source chamber includes an ion source for generating an ion beam;
said ion source chamber further includes an ion beam steering means for steering said ion beam through a curved beam-trajectory to a targeted ion-beam direction;
said ion source chamber further includes a beam deceleration means for decelerating said ion beam for producing a low energy ion beam;
said ion beam steering means coordinating with said beam deceleration means for generating an electromagnetic field for separating a neutralized particle by steering a neutralized particle to transmit in a neutralized-particle direction slightly different from said targeted ion-beam direction; and
an ion-beam deceleration optics further includes electrodes for filtering charged particles of said ion beam for generating a spread-out ion beam over an angular range along a beam line of said ion beam according to an energy of each ion of said ion beam for more accurately controlling said energy of said ions for implantation and for blocking said neutralized particle and said ions above a maximum implant energy from reaching said target for implantation.

2. The ion implantation apparatus of claim 1 wherein:
said ion-beam deceleration optics includes a first, a second and a third electrodes arranged in sequence along an incident direction of said ion beam for generating a ion-beam filtering electric field wherein said second electrode is provided with a more negative voltage than said first electrode and said third electrode is provided with a move positive voltage than said first electrode.

3. The ion implantation apparatus of claim 2 wherein:
said first electrode is provided with a voltage same as an ion source voltage and said third electrode is provided with a voltage same as a wafer voltage.

4. The ion implantation apparatus of claim 3 wherein:
said third voltage is provided with a wafer voltage connected to a ground voltage.

5. The ion implantation apparatus of claim 1 wherein:
said ion beam steering means includes an analyzer magnet for steering said ion beam through said curved beam-trajectory producing a beam-curvature spread having a range of radius R of said curved beam-trajectory as R=K* [M*E]^{0.5}/B and K being a constant, M being a mass of an ion particle of said ion beam, B being a magnetic field of said magnetic analyzer, and E being an energy level of an ion in said ion beam.

6. The ion implantation apparatus of claim 1 wherein:
said ion-beam deceleration optics further includes a neutralized beam blocking means for blocking said neutralized particle from reaching said target of implantation in said target chamber.

7. The ion implantation apparatus of claim 1 wherein:
said beam deceleration means further includes a high energy beam blocking means for blocking ions of said ion beam having an energy higher than a maximum implant energy by placing said high energy beam blocking means at an pre-designated angular position along said beam line corresponding to an angular range for blocking ions of said ion beam having an energy higher than said maximum implant energy.

8. The ion implantation apparatus of claim 1 wherein:
said ion-beam deceleration optics includes at least two beam-path openings on ion-source chamber for transmitting said ion beam steered by said steering means with a curved beam-trajectory having a range of trajectory radii.

9. The ion implantation apparatus of claim 1 wherein:
said ion source is an ion source for generating a positive charged ion beam and said beam deceleration optics includes said electrodes for generating a negative energy filtering electric-field for decelerating and filtering said ion beam for producing a spreading-out ion beam over an angular range along said beam line of said ion beam.

10. The ion implantation apparatus of claim 1 wherein:
said ion beam steering means coordinating with said beam deceleration means for steering said ion beam carrying electric charges to transmit in said targeted ion-beam direction having a small vertically deflected angle, along the dispersive plane defined by the analyzer magnet, of about six-degree relative to a horizontal axis; and
said target chamber containing said target for implantation leans at a small angle of about six-degree relative to a vertical axis perpendicular to said horizontal axis whereby said target for implantation is perpendicular to said incident angle of said ion beam.

11. The ion implantation apparatus of claim 1 wherein:
said ion source chamber is provided with a vacuum in the range of 10⁻⁵ Torr and said ion beam is decelerating to an energy level of about 200 eV with a beam contamination of about 0.1%.

12. An ion source apparatus for generating an implantation ion beam comprising:
a beam deceleration optics for decelerating and filtering said ion beam
said beam deceleration optics further includes a plurality of electrodes for generating an electrical field for filtering and spreading out said ion beam over an angular range according to an energy of each ion of said ion beam for more accurately directing a low energy ion to a target wafer.

14. A method for generating an implantation ion beam comprising:
(a) providing an ion source for generating an ion beam;
(b) employing an analyzer magnet for steering said ion beam through a curved beam-trajectory to a targeted ion-beam direction;
(c) applying said ion beam steering means for coordinating with said beam deceleration means for generating an electromagnetic field for separating a neutralized particle by steering a neutralized particle to transmit in a neutralized-particle direction slightly different from said targeted ion-beam direction; and
(d) employing a beam deceleration optics for decelerating and filtering said ion beam for producing a spreading out beam over an angular range along a beam line of said ion beam according to an energy of ions of said ion beam and employing a high energy ion blocking means for blocking out ions having an energy higher than a maximum implant energy.
